(19) United States
(12) Patent Application Publication
(10) Pub. No.: US 2026/0233780 A1
(43) Pub. Date: Aug. 13, 2026

(54) VEHICLE STRUCTURE

(71) Applicant: Honda Motor Co., Ltd., Tokyo (JP)

(72) Inventors: Yuya KAWANO, Tokyo (JP); Toshiki MIURA, Tokyo (JP)

(73) Assignee: Honda Motor Co., Ltd., Tokyo (JP)

(21) Appl. No.: 19/386,136

(22) Filed: Nov. 11, 2025

(30) Foreign Application Priority Data
Feb. 11, 2025 (CN) 202510147226.2

(51) Int. Cl. B62D 21/15; B62D 21/02

(52) U.S. Cl. CPC B62D 21/152; B62D 21/02

(57) ABSTRACT

A vehicle structure includes: a side frame; a lower member extending in a vehicle length direction at a position more outward in a vehicle width direction than the side frame; a cross member located between a left and right pair of the side frames; and a load bearing part disposed on an outer surface of the side frame in the vehicle width direction at a position corresponding to the cross member. The lower member has an abutting part, and the abutting part is configured at a position that does not overlap with the load bearing part in the vehicle width direction. When a collision load biased toward one side of the vehicle structure is input from the front of the vehicle structure, the abutting part abuts against the load bearing part.

### CROSS-REFERENCE TO RELATED APPLICATION

This application claims the priority benefit of China application serial no. 202510147226.2, filed on February 11, 2025. The entirety of the above-mentioned patent application is hereby incorporated by reference herein and made a part of this specification.

### BACKGROUND

### Technical Field

The disclosure relates to a vehicle structure.

### Description of Related Art

In recent years, efforts to provide access to sustainable transportation systems that also consider people in vulnerable positions among traffic participants, such as the elderly, disabled, or children, are becoming active. To achieve the stated purpose, research and development aimed at further improving traffic safety and convenience through development related to collision safety performance are being pursued.

In the related art, Patent Document 1 (Japanese Patent No. 5907126) provides a vehicle structure that transmits load through contact between a connection member mounted on a lower member and a protruding member mounted on a side frame when a small overlap collision occurs in a frontal collision. However, in Patent Document 1, since the connection member is disposed to face the protruding member, when a frontal collision occurs, the connection member not only retreats and contacts the protruding member during a small overlap collision, but also retreats and contacts the protruding member in various other types of frontal collisions. Therefore, when it is needed to switch the load transmission path according to the type of frontal collision, the vehicle structure of Patent Document 1 may not necessarily transmit load efficiently. Therefore, how to design a vehicle structure that may efficiently transmit load during collision for different types of frontal collision situations is an issue that remains to be addressed.

The disclosure may address the stated issue to achieve improved collision safety performance. Moreover, the disclosure further contributes to the development of sustainable transportation systems.

### SUMMARY

The disclosure provides a vehicle structure capable of switching load transmission paths according to the type of frontal collision and achieve exemplary load transmission performance.

According to an embodiment of the disclosure, a vehicle structure includes: a side frame; a lower member extending in a vehicle length direction at a position more outward in a vehicle width direction than the side frame; a cross member located between a left and right pair of the side frames; and a load bearing part disposed on an outer surface of the side frame in the vehicle width direction at a position corresponding to the cross member. The lower member has an abutting part, and the abutting part is configured at a position that does not overlap with the load bearing part in the vehicle width direction. When a collision load biased toward one side of the vehicle structure is input from the front of the vehicle structure, the abutting part abuts against the load bearing part.

### BRIEF DESCRIPTION OF THE DRAWINGS

FIG. 1 is a schematic diagram of a vehicle structure according to an embodiment of the disclosure.

FIG. 2 is a side view schematic diagram of the vehicle structure shown in FIG. 1.

FIG. 3A is a top view schematic diagram of the vehicle structure shown in FIG. 2.

FIG. 3B is a partially enlarged schematic diagram of the vehicle structure shown in FIG. 3A.

FIG. 3C is a partially enlarged schematic diagram of the vehicle structure shown in FIG. 3A near the load bearing part.

FIG. 3D is a cross-sectional schematic diagram of the cross member shown in FIG. 3A.

### DESCRIPTION OF THE EMBODIMENTS

In an embodiment of the disclosure, the lower member has a closed section formed therein that extends in a vehicle height direction in a region that overlaps with the load bearing part in the vehicle height direction and in a front region that is more forward than the load bearing part, and the closed section includes the abutting part.

In an embodiment of the disclosure, the closed section includes an inner surface part facing inward of the vehicle structure and a rear surface part facing rearward of the vehicle structure, and the rear surface part includes the abutting part.

In an embodiment of the disclosure, the vehicle structure further includes: a connection member that connects a front region of the side frame with a front region of the lower member and extends in the vehicle width direction, and the side frame and the closed section are separately configured in the vehicle width direction.

In an embodiment of the disclosure, in the vehicle structure, compared to a vehicle width direction separation distance between the load bearing part and the closed section of the lower member in the vehicle width direction, a vehicle length direction separation distance between the load bearing part and the closed section of the lower member in the vehicle length direction is larger, in which the vehicle width direction separation distance is a shortest distance in the vehicle width direction between an end part of the load bearing part that protrudes most toward the lower member and an end part of the closed section of the lower member that protrudes most toward the side frame, and the vehicle length direction separation distance is a shortest distance in the vehicle length direction between an end part of the load bearing part that protrudes most toward the lower member and an end part of the closed section of the lower member that protrudes most toward the side frame.

In an embodiment of the disclosure, the load bearing part is disposed to protrude outward in the vehicle width direction from the outer surface of the side frame, the load bearing part, when observed from above, has a front slope part, the front slope part inclines outward in the vehicle width direction and rearward of the vehicle structure, and when a collision load biased toward one side is input from the front of the vehicle structure, the front slope part abuts against the abutting part.

In an embodiment of the disclosure, when observed from above, the load bearing part is formed with a mountain-shaped part, the mountain-shaped part has the front slope part, a rear slope part, and a top part where the front slope part and the rear slope part intersect, and a rear end part region of the rear slope part is connected to the outer surface of the side frame.

In an embodiment of the disclosure, the cross member is fixed to the side frame through multiple fixation parts having spacing in the vehicle length direction, the fixation parts include a front fixation part disposed at the front of the vehicle structure and a rear fixation part disposed at a rear of the vehicle structure, and when observed from above, the top part is disposed between a region of the front fixation part and the rear fixation part.

In an embodiment of the disclosure, the cross member has a partition part between the front fixation part and the rear fixation part that divides a cross section of the cross member in a front-rear direction.

In an embodiment of the disclosure, an outer end of the cross member has an inclined end part when observed from above, and an extension direction of the inclined end part intersects with an extension line of the front slope part.

In an embodiment of the disclosure, the load bearing part has an outer surface connection part, the outer surface connection part is connected to the outer surface of the side frame on at least one of above and below the front slope part, and the inclined end part is configured parallel to the outer surface connection part when observed from above.

Based on the above, in the embodiment of the disclosure, the vehicle structure may form different transmission paths of the load according to different types of frontal collision through the configuration in which the abutting part of the lower member is disposed at a position that does not overlap with the load bearing part disposed on the outer surface of the side frame in the vehicle width direction. More specifically, in the embodiment, when the vehicle structure encounters an offset collision or other situations where a forward or diagonal collision load is input from one side biased toward the front of the vehicle structure, the lower member may rotate around the center of gravity of the vehicle structure due to torque formed by the forward collision load, or may move due to impact of rearward and inward components of the collision load. Thus, diagonal movement toward the rear and inward may be formed, causing the abutting part of the lower member to abut against the load bearing part. On the other hand, in the situation where the collision load input from the front part of the vehicle structure involves the entire front part of the vehicle structure (for example, full wrap collision), since the collision load borne by the lower member does not have an inward vector, the abutting part of the lower member may move directly rearward without contacting the load bearing part. Thus, the transmission path of load may be designed or switched according to various types of frontal collision (offset collision or full wrap collision with collision loads having different inward components), and exemplary load transmission performance may be achieved.

In order to make the above-mentioned features and advantages of the disclosure comprehensible, embodiments accompanied with drawings are described in detail as follows.

Reference is now made in detail to exemplary embodiments of the disclosure, and examples of the exemplary embodiments are illustrated in the accompanying drawings. Wherever possible, the same reference numerals are used in the accompanying drawings and descriptions to refer to the same or similar parts.

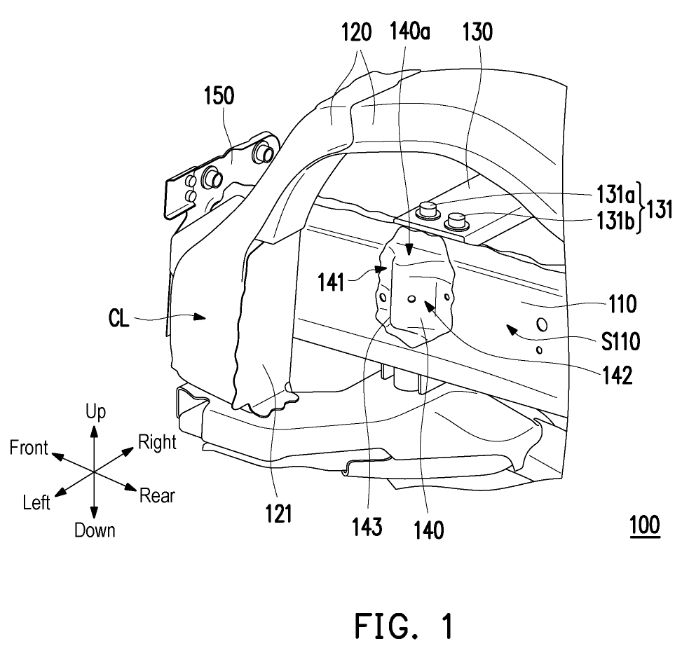

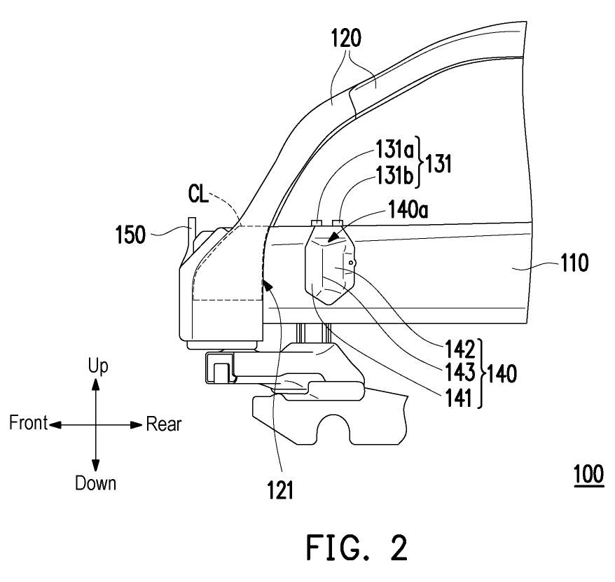

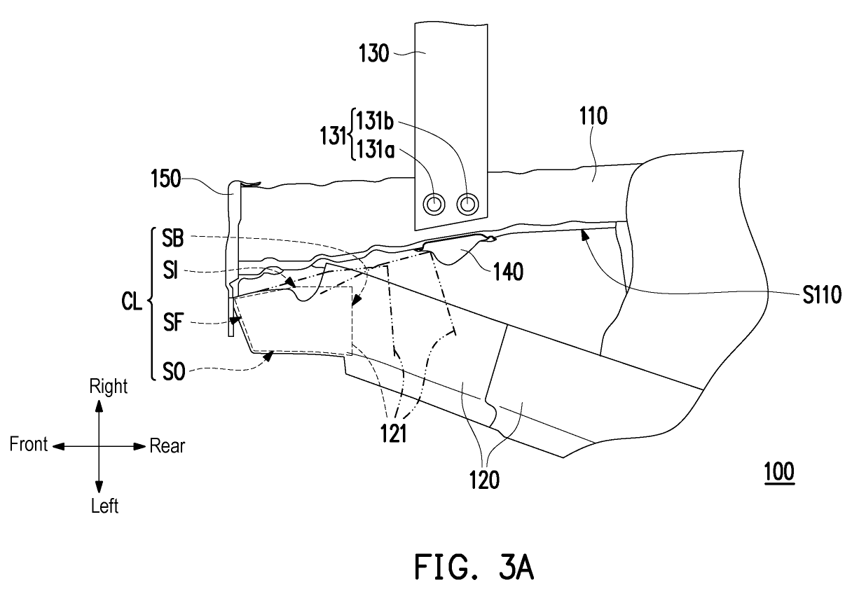

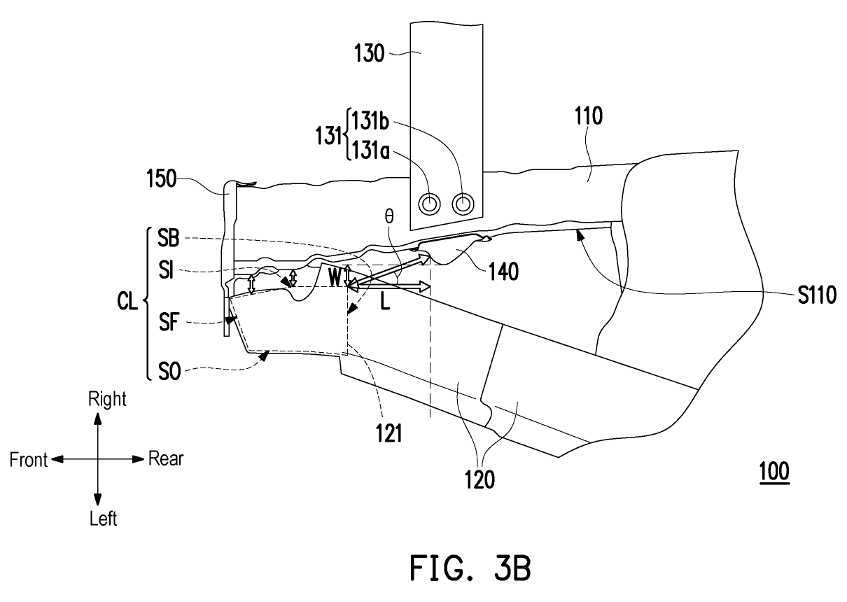

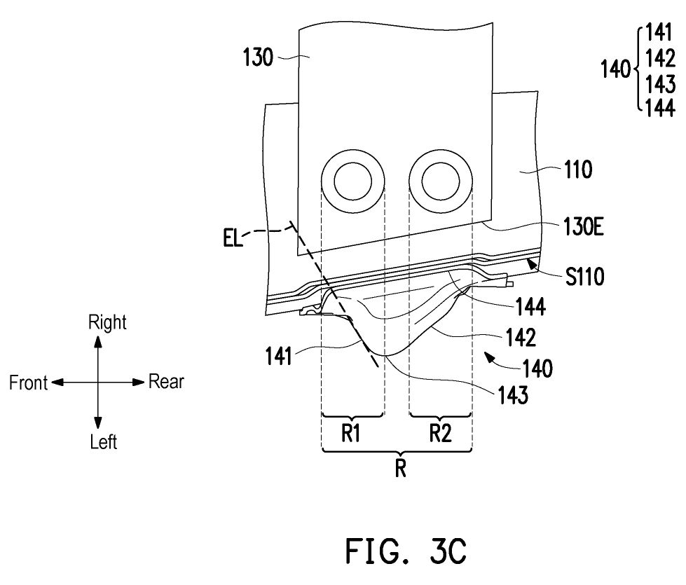

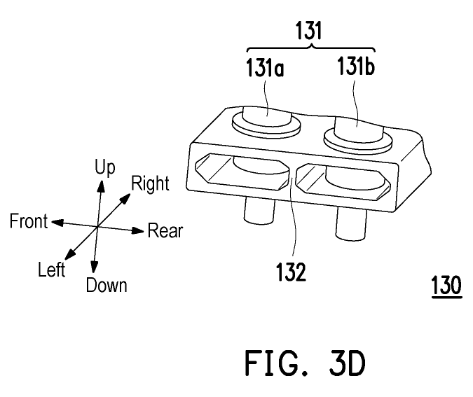

FIG. 1 is a schematic diagram of a vehicle structure according to an embodiment of the disclosure; FIG. 2 is a side view schematic diagram of the vehicle structure shown in FIG. 1; FIG. 3A is a top view schematic diagram of the vehicle structure shown in FIG. 2; FIG. 3B is a partially enlarged schematic diagram of the vehicle structure shown in FIG. 3A; FIG. 3C is a partially enlarged schematic diagram of the vehicle structure shown in FIG. 3A near the load bearing part; FIG. 3D is a cross-sectional schematic diagram of the cross member shown in FIG. 3A. It should be noted that, for convenience, a front-rear direction, a left-right direction, and an up-down direction of the vehicle structure are defined as shown in the figures, and the configuration of each of parts is described according to the definition, and the front-rear direction, the left-right direction, and the up-down direction of the vehicle structure correspond to a vehicle length direction, a vehicle width direction, and a vehicle height direction, respectively.

Referring to FIG. 1 and FIG. 2, in the embodiment, a vehicle structure 100 includes a side frame 110, a lower member 120, a cross member 130, and a load bearing part 140. Specifically, as shown in FIG. 1, in the embodiment, the lower member 120 extends in the vehicle length direction at a position more outward in the vehicle width direction than the side frame 110. The cross member 130 is located between a left and right pair of the side frames 110, and the load bearing part 140 is disposed on an outer surface S110 of the side frame 110 in the vehicle width direction at a position corresponding to the cross member 130. Moreover, as shown in FIG. 1 and FIG. 2, in the embodiment, the lower member 120 has an abutting part 121, and the abutting part 121 is configured at a position that does not overlap with the load bearing part 140 in the vehicle width direction.

Thus, as shown in FIG. 3A, in the embodiment, when a collision load biased toward one side of the vehicle structure 100 (i.e., offset collision load) is input from the front of the vehicle structure 100, the abutting part 121 may move rearward and inward in the vehicle width direction to contact the load bearing part 140, and abut against the load bearing part 140. At this time, the collision load passes through the lower member 120, the load bearing part 140, the side frame 110, and the cross member 130 in sequence, so that while the collision load is transmitted, a transmission direction thereof also changes from the vehicle length direction to the vehicle width direction, enabling the vehicle structure 100 to move in a direction away from the collision object. On the other hand, when the collision load input from the front of the vehicle structure 100 involves the entire front of the vehicle structure 100 and is uniformly applied to both left and right sides of the vehicle structure 100 (for example, full wrap collision), the abutting part 121 may move rearward while passing by the load bearing part 140, so the load may not be transmitted to the cross member 130. That is, the side frame 110 and the lower member 120 may deform in the vehicle length direction, thereby being compressed or folded, and thus absorbing energy.

Thus, by configuring the abutting part 121 of the lower member 120 at a position that does not overlap with the load bearing part 140 disposed on the outer surface S110 of the side frame 110 in the vehicle width direction, different transmission paths of the load may be formed according to different types of frontal collision. More specifically, in the embodiment, when the vehicle structure 100 encounters an offset collision or other situations where a forward or diagonal collision load is input from one side biased toward the front of the vehicle structure 100, the lower member 120 may rotate around the center of gravity of the vehicle structure due to torque formed by the forward collision load, or may move due to impact of rearward and inward components of the collision load. Thus, diagonal movement toward the rear and inward may be formed, causing the abutting part 121 of the lower member 120 to abut against the load bearing part 140. On the other hand, in the situation where the collision load input from the front part of the vehicle structure 100 involves the entire front part of the vehicle structure 100 (for example, full wrap collision), since the collision load borne by the lower member 120 does not have an inward vector, the abutting part 121 of the lower member 120 may move directly rearward without contacting the load bearing part 140. Thus, the transmission path of load may be designed or switched according to various types of frontal collision (offset collision or full wrap collision with collision loads having different inward components), and exemplary load transmission performance may be achieved.

Furthermore, as shown in FIG. 1 to FIG. 3A, in the embodiment, the lower member 120 forms a closed section CL extending along the vehicle height direction in a region that overlaps with the load bearing part 140 in the vehicle height direction and in a front region that is more forward than the load bearing part 140. Specifically, the closed section CL includes an outer surface part SO facing the outside of the vehicle structure 100, a front surface part SF facing the front of the vehicle structure 100, an inner surface part SI facing the inside of the vehicle structure 100, and a rear surface part SB facing the rear of the vehicle structure 100, and in the embodiment, the abutting part 121 is a part of the rear surface part SB, that is, the rear surface part SB of the closed section CL includes the abutting part 121. Thus, when a collision load biased toward one side of the vehicle structure 100 is input from the front of the vehicle structure 100, causing the abutting part 121 to contact the load bearing part 140, the reinforcement effect due to the closed section CL may suppress deformation of the abutting part 121 (rear surface part SB), enabling the collision load to be appropriately transmitted to the load bearing part 140.

As shown in FIG. 1, FIG. 3A and FIG. 3B, in the embodiment, the vehicle structure 100 further includes a connection member 150 connecting the front region of the side frame 110 and the front region of the lower member 120. For example, in the embodiment, the connection member 150 may be a bumper beam connection part. As shown in FIG. 1 and FIG. 3A, in the embodiment, the connection member 150 extends along the vehicle width direction, and as shown in FIG. 3B, behind the connection member 150, the side frame 110 and the closed section CL of the lower member 120 are separately configured in the vehicle width direction. Thus, as shown in FIG. 3B, when a collision load biased toward one side in the vehicle width direction is applied, the space where the closed section CL of the lower member 120 is separated from the side frame 110 may be formed as a movement stroke region, which makes the movement of the abutting part 121 toward the rear and inward in the vehicle width direction easier to control. Moreover, based on the magnitude of the inward direction vector of the collision load, an angle θ of the diagonal movement of the abutting part 121 of the lower member 120 may be adjusted by adjusting the separation distance between the side frame 110 and the closed section CL of the lower member 120.

In contrast, in the vehicle structure of Patent Document 1 as a comparative structure, the lower member of Patent Document 1 is connected to the outer surface of the side frame, and thus, when a collision load biased toward one side of the vehicle structure is input from the front of the vehicle structure of Patent Document 1, since the lower member also moves toward the rear of the vehicle structure along with the deformation of the side frame, it is difficult to move the lower member to the expected angle.

Furthermore, as shown in FIG. 3B, in the vehicle structure 100 of the embodiment, compared to a vehicle width direction separation distance W between the load bearing part 140 and the closed section CL of the lower member 120 in the vehicle width direction, a vehicle length direction separation distance L between the load bearing part 140 and the closed section CL of the lower member 120 in the vehicle length direction is larger. Here, the vehicle width direction separation distance W refers to the shortest distance in the vehicle width direction between the end part of the load bearing part 140 that protrudes most toward the lower member 120 and the end part of the closed section CL of the lower member 120 that protrudes most toward the side frame 110, and the vehicle length direction separation distance L refers to the shortest distance in the vehicle length direction between the end part of the load bearing part 140 that protrudes most toward the lower member 120 and the end part of the closed section CL of the lower member 120 that protrudes most toward the side frame 110.

Thus, when a collision load biased toward one side of the vehicle structure 100 is input from the front of the vehicle structure 100 and the abutting part 121 of the closed section CL moves toward the rear and inward in the vehicle width direction, through the structural configuration that makes the vehicle length direction separation distance L larger than the vehicle width direction separation distance W, the closed section CL of the lower member 120 may move toward the inside of the vehicle structure 100 during the process of moving within the space of the longer vehicle length direction separation distance L (i.e., long collision stroke).

In contrast, in the vehicle structure of Patent Document 1 as a comparative structure, when the vehicle width direction separation distance W is larger than the vehicle length direction separation distance L, the vehicle structure of Patent Document 1 needs to make the abutting part move diagonally within the space of the shorter vehicle length direction separation distance L (i.e., short collision stroke), which makes the adjustment of the diagonal movement of the abutting part more complex and difficult.

On the other hand, as shown in FIG. 3A, in the embodiment, the load bearing part 140 is disposed to protrude outward in the vehicle width direction from the outer surface S110 of the side frame 110. Furthermore, the load bearing part 140 is formed with a mountain-shaped part 140a when observed from above, the mountain-shaped part 140a has a front slope part 141, a rear slope part 142, and a top part 143 where the front slope part 141 and the rear slope part 142 intersect, and a rear end part region of the rear slope part 142 is connected to the outer surface S110 of the side frame 110. The front slope part 141 inclines outward in the vehicle width direction and toward the rear of the vehicle structure 100. When a collision load biased toward one side is input from the front of the vehicle structure 100, the front slope part 141 abuts against the abutting part 121.

Thus, since the load bearing part 140 is formed in a mountain shape when observed from above, and the rear end part of the rear slope part 142 is connected to the outer surface S110 of the side frame 110, the load input to the front slope part 141 may be transmitted to the side frame 110 through the rear slope part 142, while suppressing deformation of the front slope part 141 toward the outside and rear of the vehicle structure 100 (i.e., situations where the front slope part 141 exhibits rotational or torsional deformation), thereby enabling the load to be appropriately transmitted from the abutting part 121 to the load bearing part 140. Moreover, through the configuration where the front slope part 141 inclines outward in the vehicle width direction and toward the rear of the vehicle structure 100, when a collision load biased toward one side of the vehicle structure 100 is input from the front of the vehicle structure 100 and the abutting part 121 moves inward in the vehicle width direction and toward the rear (diagonal direction) (as shown by the dashed trajectory of the abutting part 121 in FIG. 3A), the abutting part 121 may contact the front slope part 141 inclined along the diagonal direction in a face-to-face manner, thereby enabling appropriate load transmission.

Furthermore, as shown in FIG. 3A and FIG. 3C, in the embodiment, the outer end of the cross member 130 has an inclined end part 130E when observed from above, and the extension direction of the inclined end part 130E intersects with an extension line of the front slope part 141. Moreover, the load bearing part 140 has an outer surface connection part 144, the outer surface connection part 144 is connected to the outer surface S110 of the side frame 110 on at least one of above and below the front slope part 141, and the inclined end part 130E is configured parallel to the outer surface connection part 144 when observed from above. Thus, the cross member 130 may be positioned on the extension line of the front slope part 141 of the mountain-shaped part 140a of the load bearing part 140, thereby enabling the load to be appropriately transmitted from the load bearing part 140 to the cross member 130. Moreover, through the configuration of the inclined end part 130E formed by cutting both ends of the cross member 130 at a certain angle to match the load bearing part 140, during collision, by stably transmitting the load to the inclined end part 130E that is parallel to the outer surface connection part 144, i.e., configured at equal intervals, lateral force may be further increased.

Moreover, as shown in FIG. 3C, in the embodiment, the cross member 130 is fixed to the side frame 110 through multiple fixation parts 131 having spacing in the vehicle length direction, and the fixation parts 131 include a front fixation part 131a disposed at the front of the vehicle structure 100 and a rear fixation part 131b disposed at the rear of the vehicle structure 100. As shown in FIG. 3C, in the embodiment, when observed from above, the top part 143 of the side frame 110 is disposed in a region R that covers a disposition region R1 of the front fixation part 131a and a disposition region R2 of the rear fixation part 131b of the cross member 130. Moreover, since the load bearing part 140 has a mountain shape when observed from above, the vicinity of the top part 143 where the front slope part 141 and the rear slope part 142 of the mountain-shaped part 140a of the load bearing part 140 intersect becomes the center of mass (center of gravity position) of the load bearing part 140. Therefore, by disposing the top part 143 of the mountain-shaped part 140a of the load bearing part 140 between the region R of the front fixation part 131a and the rear fixation part 131b where the cross member 130 and the side frame 110 are fixed, the center of gravity position of a load receiving part may be positioned at the center of the cross member 130 in the vehicle length direction, thereby enabling the load to be appropriately transmitted from the load bearing part 140 to the cross member 130.

Furthermore, as shown in FIG. 3D, in the embodiment, the cross member 130 has a partition part 132 between the front fixation part 131a and the rear fixation part 131b that divides the cross section of the cross member 130 in the front-rear direction, and the partition part 132 is substantially aligned with the top part 143 of the mountain-shaped part 140a of the load bearing part 140 in the vehicle width direction. Thus, by disposing the partition part 132 between the front fixation part 131a and the rear fixation part 131b of the cross member 130, the load may be appropriately transmitted to the cross member 130 through the partition part 132 near the center of gravity position of the load bearing part 140. Moreover, by making the partition part 132 have a cross-sectional shape that is symmetrical in the vehicle length direction relative to the center, the same cross-sectional design may be adopted even for vehicle structures 100 of different vehicle types, and an increase in mold costs may be suppressed.

In summary, in the embodiment of the disclosure, the vehicle structure may form different transmission paths of the load according to different types of frontal collision through the configuration in which the abutting part of the lower member is disposed at a position that does not overlap with the load bearing part disposed on the outer surface of the side frame in the vehicle width direction. More specifically, in the embodiment, when the vehicle structure encounters an offset collision or other situations where a forward or diagonal collision load is input from one side biased toward the front of the vehicle structure, the lower member may rotate around the center of gravity of the vehicle structure due to torque formed by the forward collision load, or may move due to impact of rearward and inward components of the collision load. Thus, diagonal movement toward the rear and inward may be formed, causing the abutting part of the lower member to abut against the load bearing part. On the other hand, in the situation where the collision load input from the front part of the vehicle structure involves the entire front part of the vehicle structure (for example, full wrap collision), since the collision load borne by the lower member does not have an inward vector, the abutting part of the lower member may move directly rearward without contacting the load bearing part. Thus, the transmission path of load may be designed or switched according to various types of frontal collision (offset collision or full wrap collision with collision loads having different inward components), and exemplary load transmission performance may be achieved.

Finally, it should be noted that the above embodiments are merely used to illustrate the technical solutions of the disclosure, but not to limit the technical solutions of the disclosure. Although the disclosure has been described in detail with reference to the foregoing embodiments, those of ordinary skill in the art should understand that the technical solutions described in the foregoing embodiments may still be modified, or some or all of the technical features thereof may be equivalently replaced. However, these modifications or substitutions do not make the essence of the corresponding technical solutions deviate from the scope of the technical solutions of the embodiments of the disclosure.

What is claimed is:

1. A vehicle structure, comprising:
a side frame;
a lower member, extending in a vehicle length direction at a position more outward in a vehicle width direction than the side frame;
a cross member, located between a left and right pair of the side frames; and
a load bearing part, disposed on an outer surface of the side frame in the vehicle width direction at a position corresponding to the cross member,
the lower member having an abutting part, and the abutting part being configured at a position that does not overlap with the load bearing part in the vehicle width direction, and
when a collision load biased toward one side of the vehicle structure is input from a front of the vehicle structure, the abutting part abutting against the load bearing part.

2. The vehicle structure according to claim 1, wherein
the lower member has a closed section formed therein that extends in a vehicle height direction in a region that overlaps with the load bearing part in the vehicle height direction and in a front region that is more forward than the load bearing part, and the closed section comprises the abutting part.

3. The vehicle structure according to claim 2, wherein
the closed section comprises an inner surface part facing inward of the vehicle structure and a rear surface part facing rearward of the vehicle structure, and the rear surface part comprises the abutting part.

4. The vehicle structure according to claim 2, further comprising:
a connection member, connecting a front region of the side frame with a front region of the lower member and extending in the vehicle width direction, and the side frame and the closed section being separately configured in the vehicle width direction.

5. The vehicle structure according to claim 2, wherein compared to a vehicle width direction separation distance between the load bearing part and the closed section of the lower member in the vehicle width direction, a vehicle length direction separation distance between the load bearing part and the closed section of the lower member in the vehicle length direction is larger, wherein the vehicle width direction separation distance is a shortest distance in the vehicle width direction between an end part of the load bearing part that protrudes most toward the lower member and an end part of the closed section of the lower member that protrudes most toward the side frame, and the vehicle length direction separation distance is a shortest distance in the vehicle length direction between an end part of the load bearing part that protrudes most toward the lower member and an end part of the closed section of the lower member that protrudes most toward the side frame.

6. The vehicle structure according to claim 1, wherein
the load bearing part is disposed to protrude outward in the vehicle width direction from the outer surface of the side frame,
the load bearing part, when observed from above, has a front slope part, the front slope part inclines outward in the vehicle width direction and rearward of the vehicle structure, and when a collision load biased toward one side is input from the front of the vehicle structure, the front slope part abuts against the abutting part.

7. The vehicle structure according to claim 6, wherein when observed from above, the load bearing part is formed with a mountain-shaped part, the mountain-shaped part has the front slope part, a rear slope part, and a top part where the front slope part and the rear slope part intersect, and a rear end part region of the rear slope part is connected to the outer surface of the side frame.

8. The vehicle structure according to claim 7, wherein
the cross member is fixed to the side frame through a plurality of fixation parts having spacing in the vehicle length direction, the plurality of fixation parts comprise a front fixation part disposed at the front of the vehicle structure and a rear fixation part disposed at a rear of the vehicle structure, and when observed from above, the top part is disposed between a region of the front fixation part and the rear fixation part.

9. The vehicle structure according to claim 8, wherein the cross member has a partition part between the front fixation part and the rear fixation part that divides a cross section of the cross member in a front-rear direction.

10. The vehicle structure according to claim 6, wherein an outer end of the cross member has an inclined end part when observed from above, and an extension direction of the inclined end part intersects with an extension line of the front slope part.

11. The vehicle structure according to claim 10, wherein the load bearing part has an outer surface connection part, the outer surface connection part is connected to the outer surface of the side frame on at least one of above and below the front slope part, and the inclined end part is configured parallel to the outer surface connection part when observed from above.
